(19) United States
(12) Patent Application Publication
(10) Pub. No.: US 2010/0043883 A1
(43) Pub. Date: Feb. 25, 2010

(54) SYSTEM AND METHOD FOR AUTOMATED STERILE SAMPLING OF FLUID FROM A VESSEL

(75) Inventors: Erwin Yaokui Yu, Ballwin, MO (US); Marcel J. Meacham, Mendon, MA (US); George E. Barringer, JR., West Groton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: GROTON BIOSYSTEMS, LLC, Boxborough, MA (US)

(21) Appl. No.: 12/491,014

(22) Filed: Jun. 24, 2009

Related U.S. Application Data
(60) Provisional application No. 61/133,171, filed on Jun. 25, 2008.

(51) Int. Cl. F15D 1/00; G01N 1/12

(52) U.S. Cl. 137/1; 73/864.63; 137/561 R

(57) ABSTRACT

An automatic sterile sampling system for sampling fluid includes a steam valve, a sampling valve, a processing system, an isolation valve, and a controller. The inner diameters of the valve ports and fluid lines are less than about 8 mm. The system has tapered transitions between an outlet port of the sampling valve and an inlet port of the isolation valve and between a sample transfer port of the isolation valve and a sample transfer channel. An isolation valve drain outlet port protrudes upwardly from the isolation valve and has a longitudinal axis that is angled less than about 45° with from vertical.

### RELATED APPLICATION(S)

This application claims the benefit of U.S. Provisional Application No. 61/133,171, filed on Jun. 25, 2008. The entire teachings of the above application are incorporated herein by reference.

### BACKGROUND OF THE INVENTION

In a bioreactor process, maintaining a contamination-free environment is key. Whenever a bioprocess system is exposed to the external environment, it faces the risk of contamination by viruses, micro-organisms, and chemicals. Typical bioprocesses involve batch bioreactors where cells are cultured and harvested over a period of time ranging from minutes to days. After a batch is harvested, the reactor vessel is sterilized in preparation for the next batch process. For small volume reactors, the entire reactor system can be placed in an autoclave and completely sterilized. For example, reactors that are about 5 liters or less typically are made of glass and are sterilized in an autoclave. However, large volume reactors, such as those that are about 5 liters or more are typically too large to be placed in an autoclave, and must therefore be sterilized using Clean-in-Place (CIP) and Steam-in-Place (SIP) methods. CIP and SIP are methods used in the pharmaceutical and food industries for the in-line sterilization of processing equipment, including vessels, valves, process lines, and filter assemblies. These methods are used to achieve sterility or a certain level of sanitation required by regulation for a particular process.

In many cases, bioreactor processes do not lend themselves easily to in-situ analysis of the batch. Instead, samples must be physically extracted from the process and examined and manipulated outside the vessel, thereby exposing the entire batch to the external environment and the possibility of contamination. Since loss of a sample run or contamination of the process can have extremely expensive ramifications, it is important to obtain a sample without causing contamination. Furthermore, to minimize waste of the batch material, it is desirable to extract a sample only in the amount necessary for processing and analysis.

Many reactors are equipped with a sampling valve whereby the contents of the reactor may be extracted. Referring to FIG. 1, a sampling valve 3 of a fluid sample source 1 is connected to capped input and output ports, 7 and 9, respectively. The typical process for extracting a sample from a reactor involves manual operation. A human operator first opens the capped input port 7 and drain output port 9. The operator then uses a tri-clamp to connect a steam source 5 to the input port 7 and a steam drain 10 to the drain output port 9. The operator opens a steam valve 13 to permit steam from steam source 5 to pass for a specified amount of time through the input port 7, sampling valve 3, and drain output port 9 and to exit to the drain. Once the sampling valve 3 is sufficiently sterilized, the operator terminates the steam operation by closing the steam valve 13. The operator then disconnects drain output port 9 from the drain and manually draws a sample from the reactor 1 through the sample valve 3 and drain output port 9 into a container. After the sample has been extracted, the operator can optionally sterilize the system again by reconnecting the drain output port 9 to the drain and opening steam valve 13 to run steam through the components, as described above. Finally, the operator disconnects the drain output port 9 from the drain and disconnects the steam input port 7 from the steam source, recapping both ports.

The described process is susceptible to the introduction of contamination in various ways; the sterilizing and sampling processes are always subject to the possibility of human error, and the routine connecting and disconnecting of the lines brings constant exposure of the system to contamination from the external environment. In some instances, the sample may leak from the sampling valve, unnecessarily wasting portions of the batch and, if the batch material is biohazardous, possibly injuring the operator. In addition, the process places the operator at risk of bum injuries during the steam operation.

### SUMMARY OF THE INVENTION

What is needed is an improved system and method for acquiring samples from a bioreactor that is safer, more consistent, and less susceptible to contamination.

In one aspect, provided is an automatic sterile sampling system for sampling fluid, including a steam valve; a sampling valve having a steam inlet port in fluid communication with the steam valve, a sample inlet port, and an outlet port, the outlet port having a first inner diameter; a processing system comprising a cleaning fluid source and in fluid communication with a sample transfer channel, the sample transfer channel having a second inner diameter less than the first inner diameter; an isolation valve having an inlet port in fluid communication with the outlet port of the sampling valve, a drain outlet port, and a sample transfer port in fluid communication with the sample transfer channel, the inlet port and sample transfer port having a third inner diameter less than the first inner diameter and larger than the second inner diameter; and a controller. The inner diameters of the valve ports and fluid lines are less than about 8 mm. The system has tapered transitions between the outlet port of the sampling valve and the inlet port of the isolation valve and between the sample transfer port of the isolation valve and the sample transfer channel. The isolation valve drain outlet port protrudes upwardly from the isolation valve and has a longitudinal axis that is angled less than about 45° with respect to vertical.

In another aspect, provided is a method for automatic aseptic sampling from a fluid sample source, including the steps of: providing a steam source, a steam valve connected the steam source, a sampling valve connected to the fluid sample source, an isolation valve, a processing system, a drain valve, a drain, and a controller; and employing the controller to pass cleaning fluid from the processing system through the isolation valve to the drain; pass steam through the steam valve, sampling valve, and isolation valve to the drain for a duration sufficient to sterilize the sampling valve, the isolation valve, and a fluid path therebetween; and pass fluid sample from the fluid sample source through the sampling valve and isolation valve to the processing system.

Thus provided are a system and a method that delivers safer, more consistent sampling, while reducing the risk of contamination during extraction of a sample from a vessel. Waste of the sample can also be minimized.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a drawing of a manually operated sampling system connected to a bioreactor;

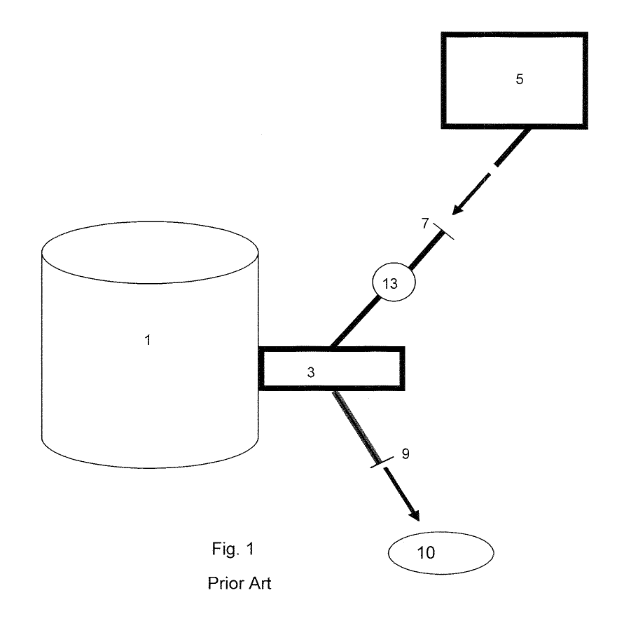

FIG. 2 is a drawing of the automated system at rest;

FIG. 3 is a drawing of the isolation valve and drain valve functioning in cooperation during a sterilizing operation;

FIG. 4 is a drawing of the isolation valve and drain valve functioning in cooperation during a sampling operation;

FIG. 5a is a drawing of the isolation valve and drain valve functioning in cooperation during a first part of a sanitizing operation;

FIG. 5b is a drawing of the isolation valve and drain valve functioning in cooperation during a second part of a sanitizing operation;

FIG. 6 is a drawing of the control valve system for the isolation valve;

FIG. 7 is a drawing of the automated system at rest, including a controller that is separate from the processing system;

FIG. 8a is a drawing of the automated system during a first part of a sanitizing operation;

FIG. 8b is a drawing of the automated system during a second part of a sanitizing operation;

FIG. 9 is a drawing of the automated system during a sterilizing operation;

FIG. 10 is a drawing of the sampling valve during a sterilizing operation;

FIG. 11 is a drawing of the sampling valve during a sampling operation;

FIG. 12 is a drawing of the automated system during a sterilizing operation, including sterilizing a portion of the sample transfer channel;

FIG. 13 is a drawing of the automated system during a cooling operation;

FIG. 14 is a drawing of the automated system during a sampling operation;

FIG. 15 is a drawing of the system during a manual sampling operation;

FIG. 16 shows data comparing glucose concentration and viable cell count for samples extracted manually and automatically;

FIG. 17 is a drawing of an improved system having reoriented system components;

FIG. 18 is a drawing of the isolation valve and drain valve of an improved system functioning in cooperation during a sterilizing operation;

FIG. 19 is a drawing of the isolation valve and drain valve of an improved system functioning in cooperation during a sampling operation;

FIG. 20a is a drawing of the isolation valve and drain valve of an improved system functioning in cooperation during a first part of a sanitizing operation;

FIG. 20b is a drawing of the isolation valve and drain valve functioning in cooperation during a second part of a sanitizing operation;

FIG. 21 is a drawing of the isolation valve of FIG. 4 further showing steam condensate and a cell collecting trap;

FIG. 22 is a drawing of a tapered transition between the sampling valve output port and the steam/sample channel; and

FIG. 23 is a graph showing the cell count variance of 10 automatically extracted samples taken in sequence using the both original and modified automated sampling system.

### DETAILED DESCRIPTION OF THE INVENTION

The present invention provides improvements for an automated system and method for extracting a sample from a batch reactor while maintaining sterility of the key components through which the sample is extracted. The improvement relates to the system and method described in U.S. Ser. No. 61/133,209, entitled, “System and Method for Automated Sterile Sampling of Fluid From a Vessel,” of George E. Barringer, Jr., (Attorney Docket No. 3551.1013-000) which application is filed concurrently herewith, and which application is incorporated herein by reference in its entirety. Particularly, the improvement is directed to the automatic sterile sampling of heterogeneous fluid from a bioreactor vessel, for example, a mammalian cell culture in suspension. This invention is not limited to sampling from a bioreactor, but rather can be applied to the aseptic sampling of any vessel containing a fluid.

A description of example embodiments of the invention follows. The embodiments provide an automated system and method for extracting a sample from a batch reactor while maintaining sterility of the key components through which the sample is extracted. The invention is not limited to sampling from a bioreactor, but rather can be applied to the aseptic sampling of any vessel containing a fluid. The system employs a series of pneumatically actuated valves to control the flow of steam, fluid sample, cleaning fluid, and optionally air through the system at specified times and includes a connection whereby a fluid sample is routed from the bioreactor vessel to a downstream processing system. As used herein, the term “valve” refers to a single valve or system of valving that achieves a particular flow configuration.

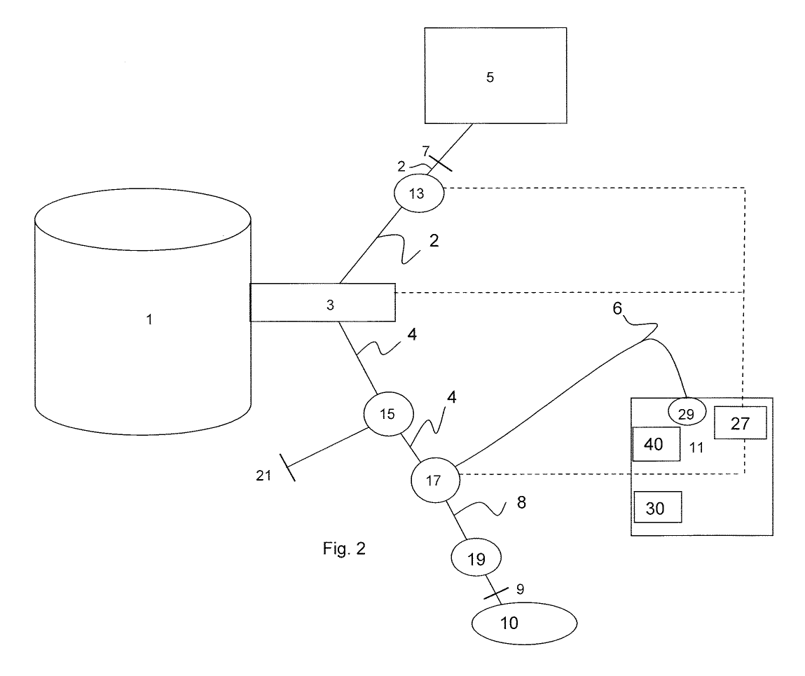

Referring to FIG. 2, the automated sampling system includes a steam channel 2 having a steam input port 7 that is semi-permanently connected to a steam source 5. The system also includes a drain channel 8 having a drain output port 9 that is semi-permanently connected to a drain. As used herein, the term “semi-permanent” refers to a connection between components that is maintained during normal operation and is ordinarily not disconnected unless system maintenance is required. Unlike previous sampling systems, the entire system is connected at all times during operation of the reactor, thereby minimizing the opportunity for exposure of the process to the external environment and reducing the likelihood of an incomplete connection between the system components.

Returning to FIG. 2, the system further includes a steam valve 13, a sampling valve 3, an isolation valve 17, an optional manual sampling valve 15, and a drain valve 19.

Steam valve 13 controls the flow of steam through a steam channel 2. Steam valve 13 is typically a diaphragm valve, such as GEMÜ® Type 650/015/D80415A0-1537, which is a ½ inch two-port pneumatically actuated sanitary valve. When steam valve 13 is open, steam is allowed to pass through steam channel 2 to sampling valve 3.

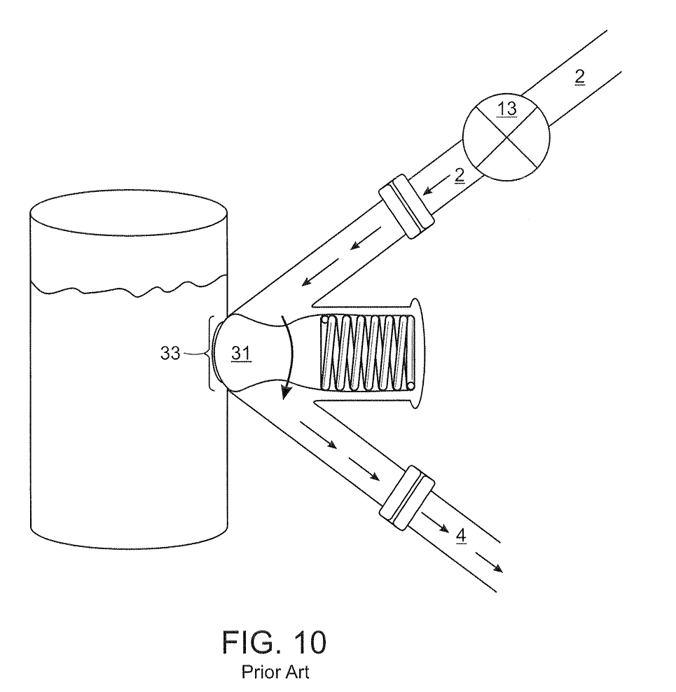

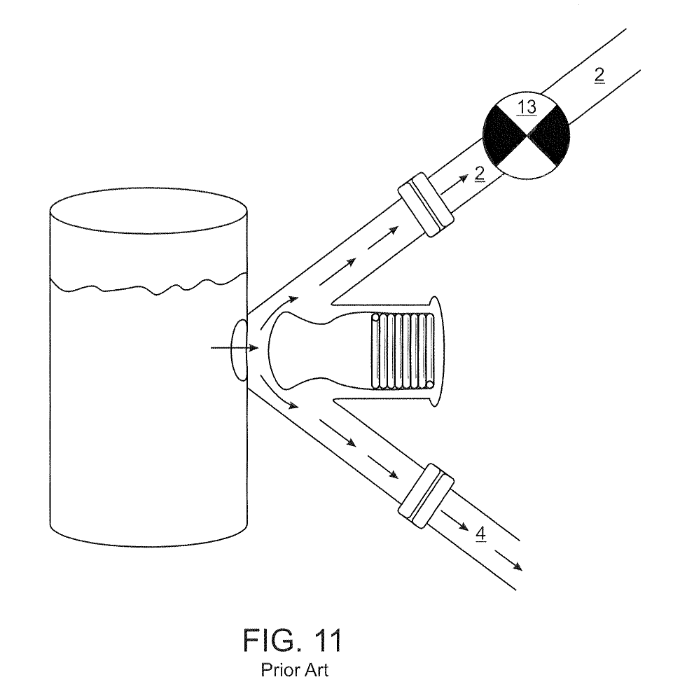

Sampling valve 3 is typically a three-port plunger valve specifically adapted for sterile sampling of a liquid sample from a container, such as the Keofitt® W15™ sampling valve, or the valves described in U.S. Patent Application Publication No. 2007/0074761 incorporated herein by reference in its entirety. An example of a suitable Keofitt® sampling valve is shown in FIGS. 10 and 11. Sampling valve 3 is connected to three components of the system: the steam channel 2, a fluid sample source 1, such as a reactor vessel, and a steam/sample channel 4. Steam and fluid samples can flow from the sampling valve 3 to isolation valve 17 through steam/sample channel 4. Steam/sample channel 4 typically has an inner diameter of about 9 mm. When closed as shown in FIG. 10, steam is able to flow from steam channel 2 to steam/sample channel 4. When opened, as shown in FIG. 11, fluid sample flows from port 33 toward steam/sample channel 4, the flow path toward steam channel 2 being blocked by steam valve 13.

Isolation valve 17 is typically a three-port diaphragm valve. An example of a suitable isolation valve is a GEMÜ® Type 650 TC TFE 15RaEP Con1, which is a ⅜ inch three-port pneumatically actuated sanitary valve. A first port of isolation valve 17 is connected to the steam/fluid channel 4, while a second port of isolation valve 17 is connected to drain channel 8 and a third port of the isolation valve 17 is connected to sample transfer channel 6.

Sample transfer channel 6 establishes fluid communication between isolation valve 17 and processing system 11. As used herein, “fluid communication” refers to a relationship between two components by which fluid can be permitted to flow from one component to the other. Processing system 11 can include cleaning, processing, and analytical instrumentation, as well as controller 27, which will be described further below. An example of a suitable processing system is described in U.S. Patent Application Publication No. 2004/0259266, incorporated herein by reference in its entirety. Processing system 11 further includes a cleaning fluid source 40, a sterile water source 30, and an internal valve 29, which opens and closes fluid communication to isolation valve 17.

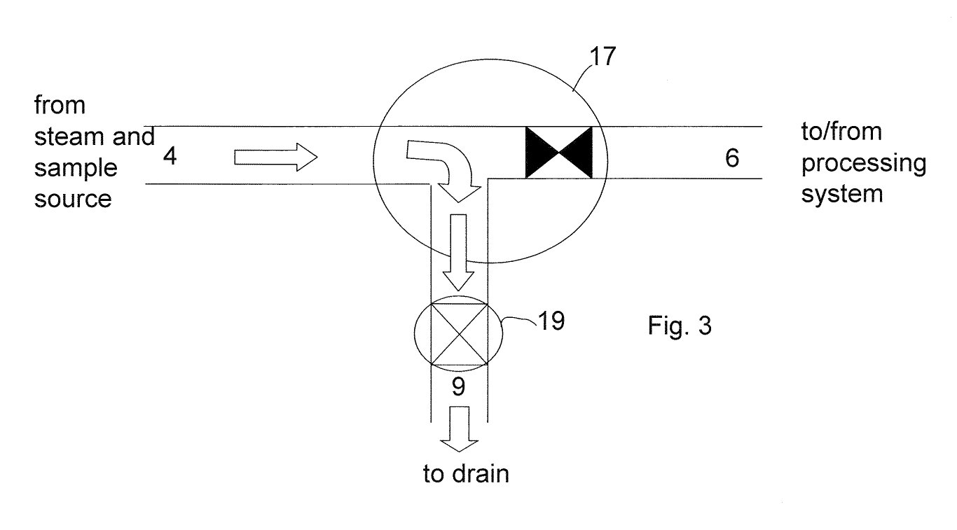

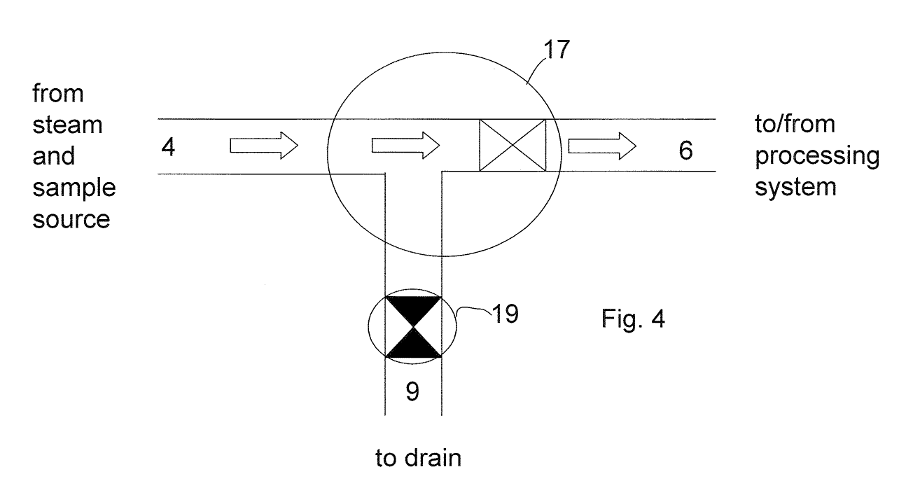

In one embodiment, the isolation valve 17 essentially operates in the manner shown in FIGS. 3, 4, 5a and 5b. In cooperation with the drain valve 19, isolation valve can pass steam and fluid samples to the drain as shown in FIG. 3, or pass fluid samples to a processing system as shown in FIG. 4. In FIG. 3, steam and fluid samples are prevented from entering sample transfer channel 6 and the processing system. In FIG. 4, fluid samples are allowed to pass to sample transfer channel 6 and enter the processing system. The sample fluid does not pass through drain valve 19, which is closed during a sampling operation.

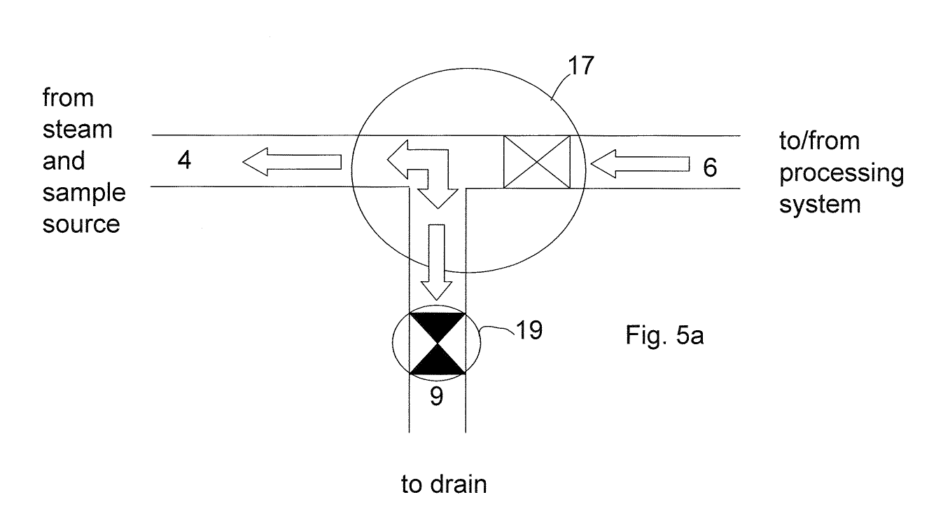

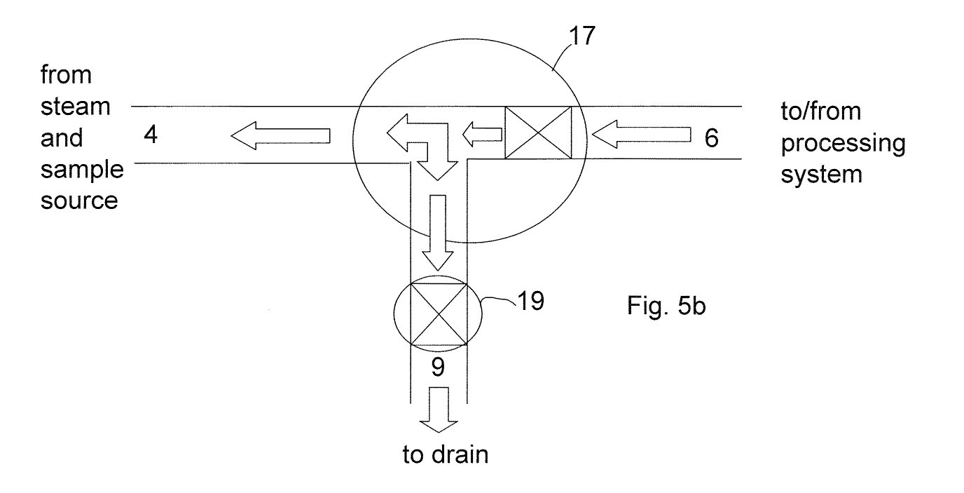

As shown in FIGS. 5a and 5b, isolation valve 17 also routes cleaning fluid from the processing system through sample transfer channel 6 to the drain. FIGS. 4, 5a, and 5b show that isolation valve 17 is in mutual fluid communication with the processing system via sample transfer channel 6. That is, fluid samples can be permitted to flow through isolation valve 17 to the processing system 11 as in FIG. 4, and cleaning fluid can be permitted to flow from the processing system 11 through isolation valve 17, as in FIGS. 5a and 5b.

The drain valve is typically similar to the isolation valve, but has two ports instead of three. An example of a suitable drain valve is a GEMÜ® Type 650 TC TFE 15RaEP Con1 having two ⅜ inch ports, which is also a pneumatically actuated sanitary valve. In the alternative, isolation valve can perform the above functions without the assistance of drain valve 19, so long as isolation valve is a true three-way valve, rather than a three-port valve with two ports always coupled together.

As shown in FIG. 2, the system may also include an optional manual sampling valve 15. Manual sampling valve is typically a three-port plunger valve, such as GEMÜ® Type 601 TC TFE 15RaEP Con A-B, which is a ⅜ inch three-port manually actuated sanitary valve. Manual sampling valve 15 is connected to an optional manual sampling output port 21, which can be used by a human operator to draw fluid samples from the fluid sample source 1. The manual valve operates in a similar manner as the isolation valve 17. However, during normal automatic operation, the valve shuts the fluid pathway to manual output port 21.

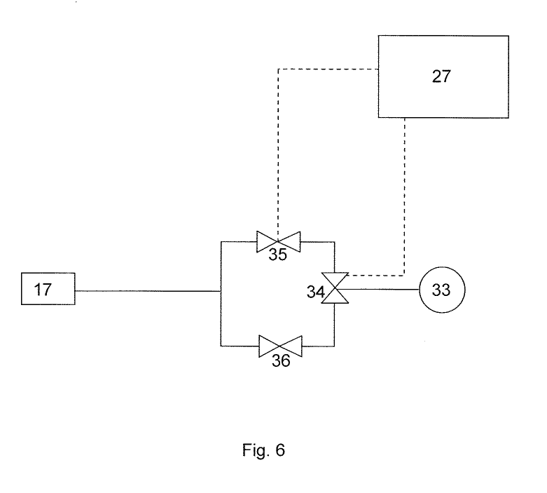

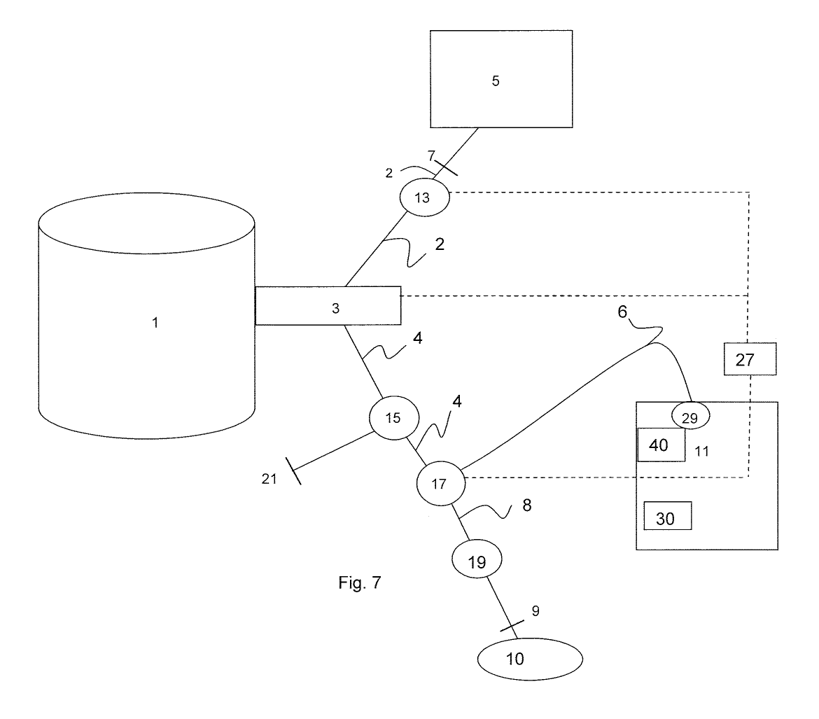

The steam valve 13, sampling valve 3, isolation valve 17, drain valve 19, and internal valve 29 are controlled in sequence to perform various system operations, which will be described in detail below. Each of the valves is pneumatically actuated by one of two control valves in parallel: a solenoid control valve and a manual control valve. For example, FIG. 6 shows isolation valve 17, which is pneumatically actuated by either manual control valve 36 or solenoid control valve 35. The user can select between automatic and manual control by toggling auto/manual solenoid switch valve 34, which is connected to compressed air source 33. The valve switches compressed air from source 33 to either the solenoid valve 35 for automatic control or manual control valve 36 for manual control. Under normal operation, the valves of the system are controlled automatically. A controller 27, such as a programmable logic controller (PLC) controls the solenoid valves and solenoid switch valves. As shown in FIG. 2, the controller typically resides in processing system 11 and controls the control valves to actuate the pneumatic valves, thereby automatically performing the various operations of the system in sequential order periodically throughout the bioreactor process. In one embodiment, such as the one shown in FIG. 7, the controller 27 is a separate component of the sampling system, and not part of the processing system 11.

### OPERATION OF THE SYSTEM

Before a new sample can be extracted from the reactor vessel, parts of the sampling system are sterilized, while others are sanitized. As used herein, the term “sterile” refers to a system or components of a system that are absolutely free of unknown living organisms or bioactive DNA. As thus defined, sterility has been proven by experiment to be achieved only by high temperature steam or radiation. As used herein, the term “sanitized” refers to a system or components of a system that are free of unknown organisms in measurable levels.

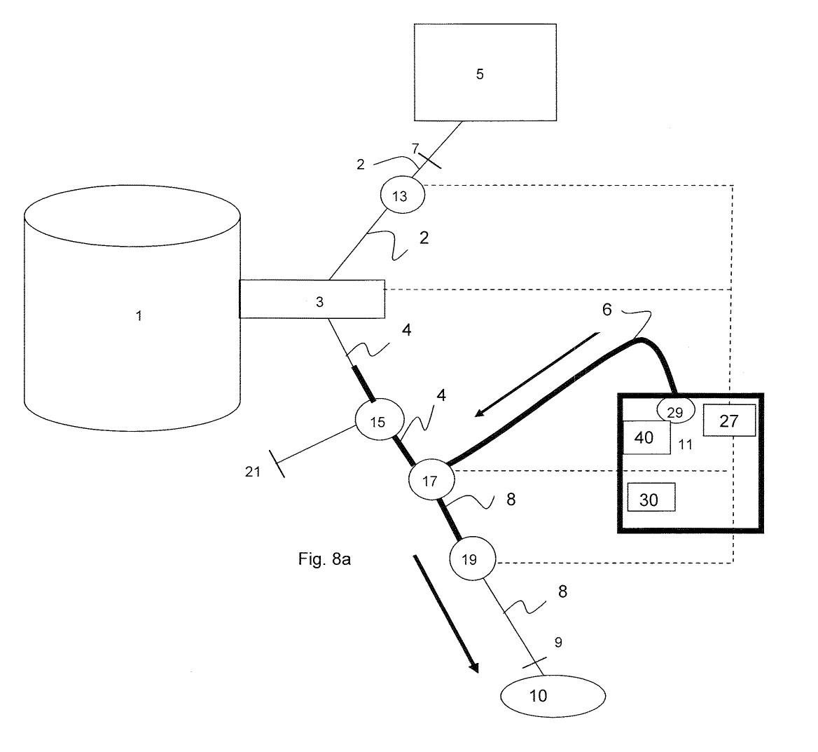

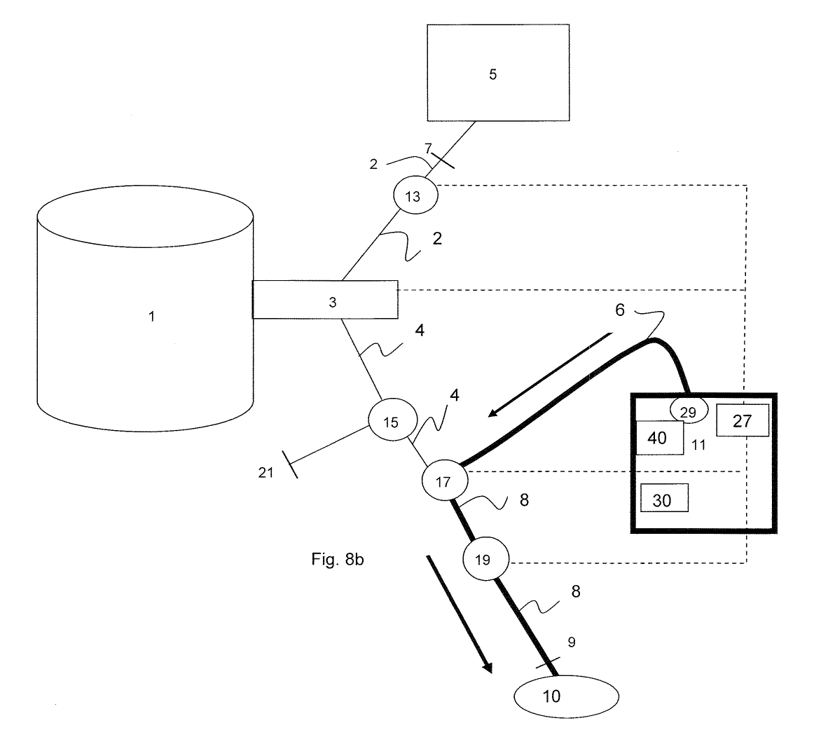

In the embodiment shown in FIGS. 8a and 8b, the sample transfer channel 6 is sanitized. Sanitizing sample transfer channel 6 ensures that any residual organisms that may exist in the sample transfer channel 6 from a prior sampling operation do not enter steam/sample channel 4 when steam/sample channel 4 and sample transfer channel 6 are in fluid communication, such as when isolation valve 17 permits a fluid sample to enter the sample transfer line 6 during a sampling operation, described further below.

Internal valve 29 opens to permit fluid to flow. For example, when internal valve 29 is open, cleaning fluid can flow from cleaning fluid source 40 through sample transfer channel 6 to isolation valve 17. As shown in FIG. 8a, drain valve 19 remains closed for the first part of the sanitizing operation. Cleaning fluid flows from the processing system 11, through sample transfer channel 6 and partially into steam/sample channel 4. Thus, the sample transfer channel 6, isolation valve 17, and a portion of steam/sample channel 4 are sanitized.

The second part of the sanitizing operation is shown in FIG. 8b. At this time, drain valve 19 opens so that cleaning fluid flows to the drain 10. The cleaning fluid flushes the isolation valve 17 and sample transfer channel 6 of any sample material remaining from the previous sampling operation. After the cleaning fluid has passed to the drain 10, internal valve 29 and drain valve 19 remain open to permit sterile water from sterile water source 30 to further rinse the sample transfer channel 6 and isolation valve 17 and exit the system via drain channel 8. At the end of the sanitizing operation, residual sterile water still remains in sample transfer channel 6.

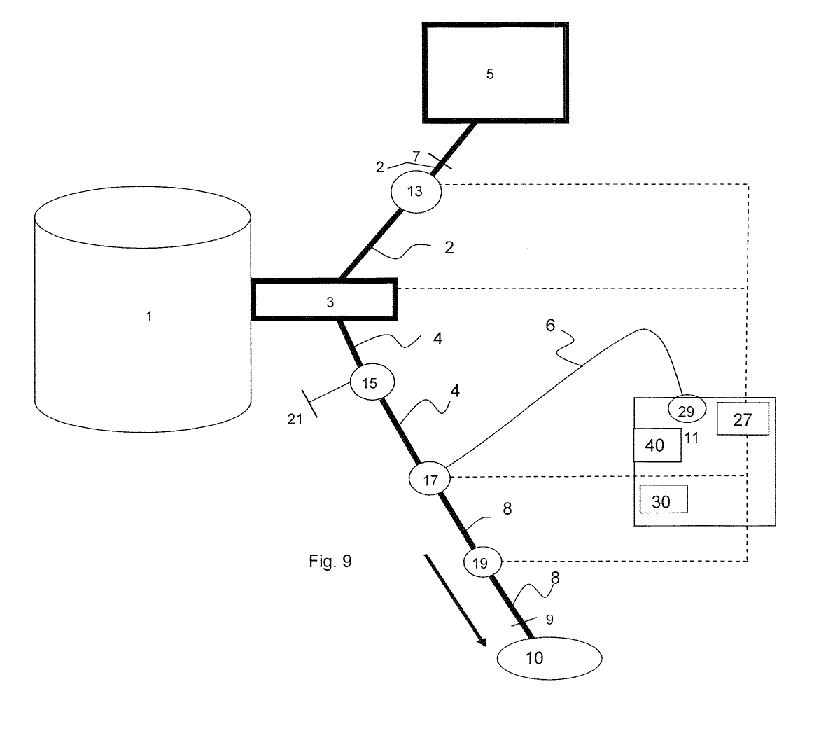

The system then undergoes a sterilizing operation, as shown in FIG. 9. Drain valve 19 remains open while internal valve 29 and isolation valve 17 are closed. As shown in FIG. 3, even when isolation valve 17 is closed, steam from steam/sample channel 4 is still permitted to pass to the drain 10. Thus, steam valve 13 is opened and steam passes from steam source 5 through steam channel 2, sampling valve 3, steam/sample channel 4, and drain channel 8 to the drain 10. Steam is allowed to flow for a specified duration and temperature that is sufficient to ensure sterilizing of sampling valve 3. The duration is typically at least about 20 minutes and the temperature of the steam is typically at least about 131 degrees Celsius. The steam pressure within the system during the sterilizing operation is greater than atmospheric pressure.

FIG. 10 shows the sterilizing of sampling valve 3 in detail. Valve head 31 is seated over an aperture 33, thereby obstructing the flow of fluid from fluid sample source 1. Steam enters sampling valve 3 from the steam source (not shown) through steam channel 2 and exits through steam/sample channel 4.

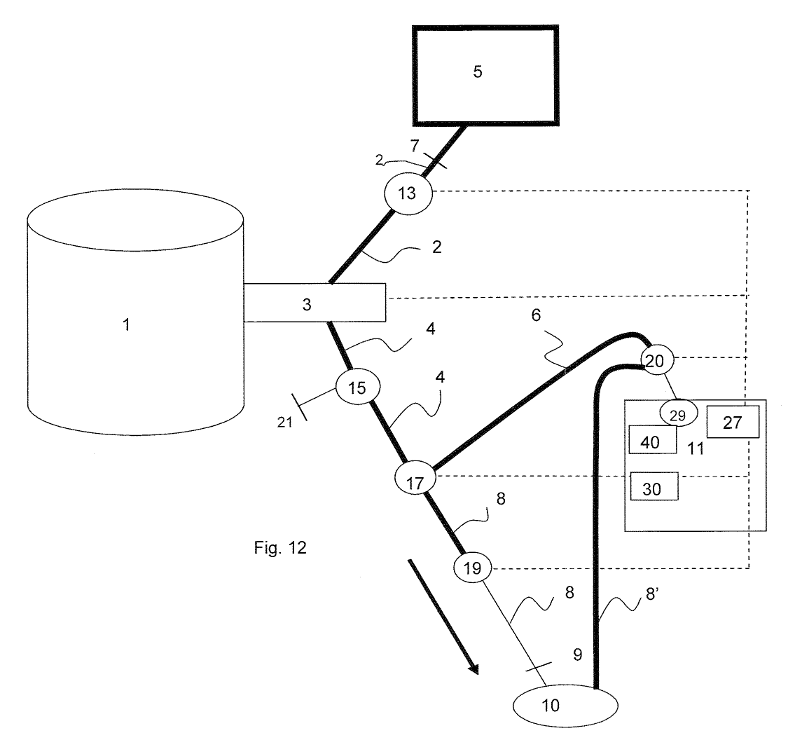

In one embodiment, sample transfer channel 6 can be at least partially sterilized. As shown in FIG. 12, a sample transfer valve 20 is positioned to allow steam to travel up the sample transfer channel 6 and to the drain 10 while blocking steam from reaching the heating processing system and causing damage to the electrical components. An additional drain channel 8′ is required for this embodiment. The sample transfer channel 6 for this embodiment preferably has an inner diameter that is greater than about 1 mm, in order to allow steam to pass through sample transfer channel 6. Most of the sample transfer channel 6 is sterilized.

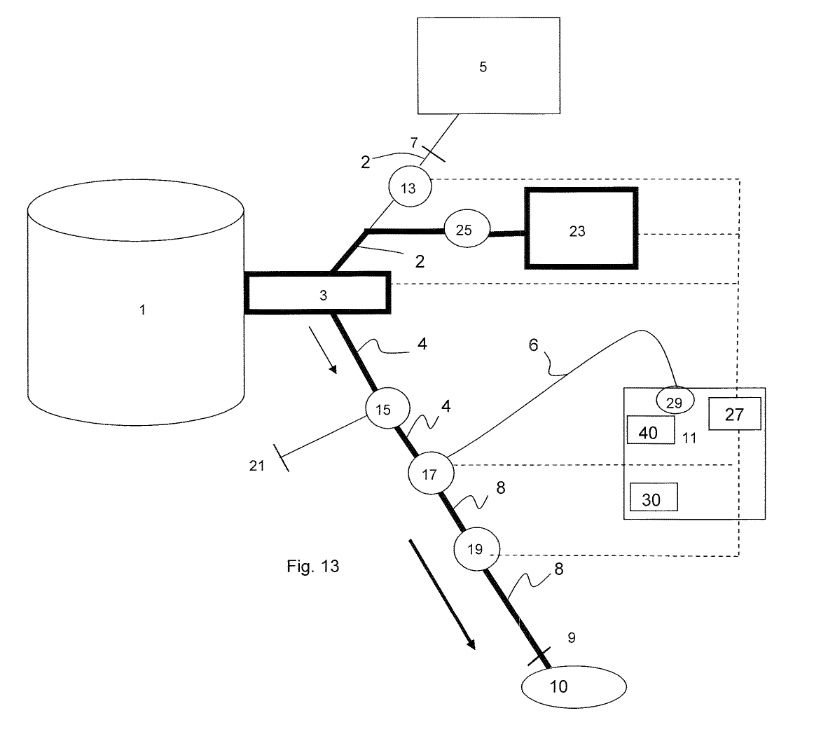

Once the sterilizing operation has completed, steam valve 13 closes and the system is sufficiently free of contamination. However, the system components generally remain hot from the sterilizing operation. To reduce the temperature of the components, the system can undergo an optional cooling operation, as shown in FIG. 13. In the cooling operation, an optional cooling valve 25, connected to an optional sterile air source 23, opens to allow sterile air to flush and cool the system components, particularly the sampling valve 3 and steam/sample channel 4. The sterile air is allowed to flow for a specified duration and temperature that is sufficient to ensure cooling of the sampling valve 3. Typically, the temperature of the sterile air is between about 15 to about 20 degrees Celsius. After the system has reached a temperature sufficient to allow a sample to be extracted from the reaction vessel, cooling valve 25 closes. This operation ensures that subsequent fluid samples, which are often proteinaceous, do not denature in the system.

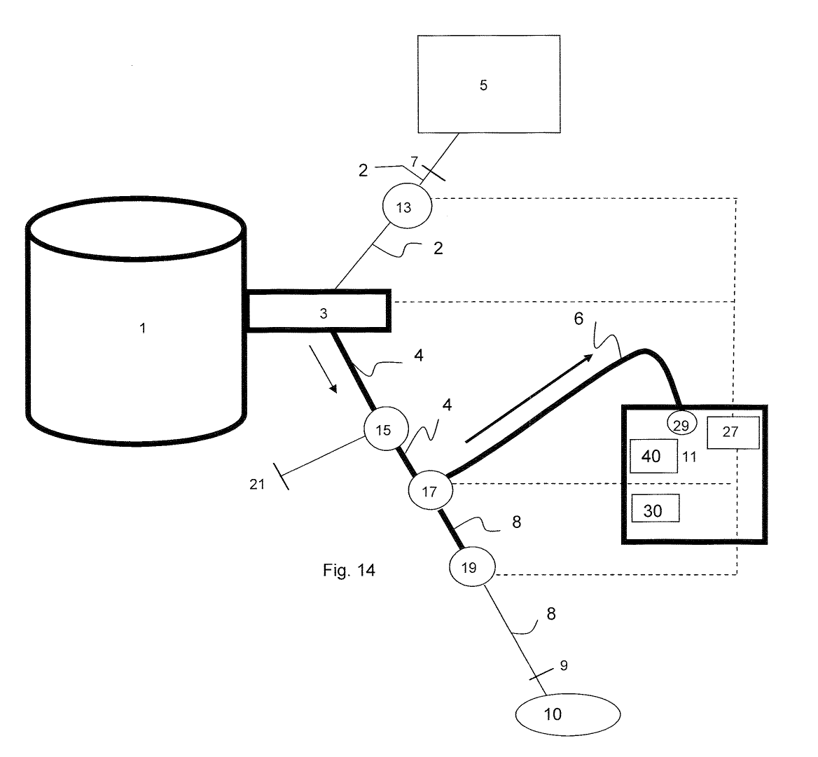

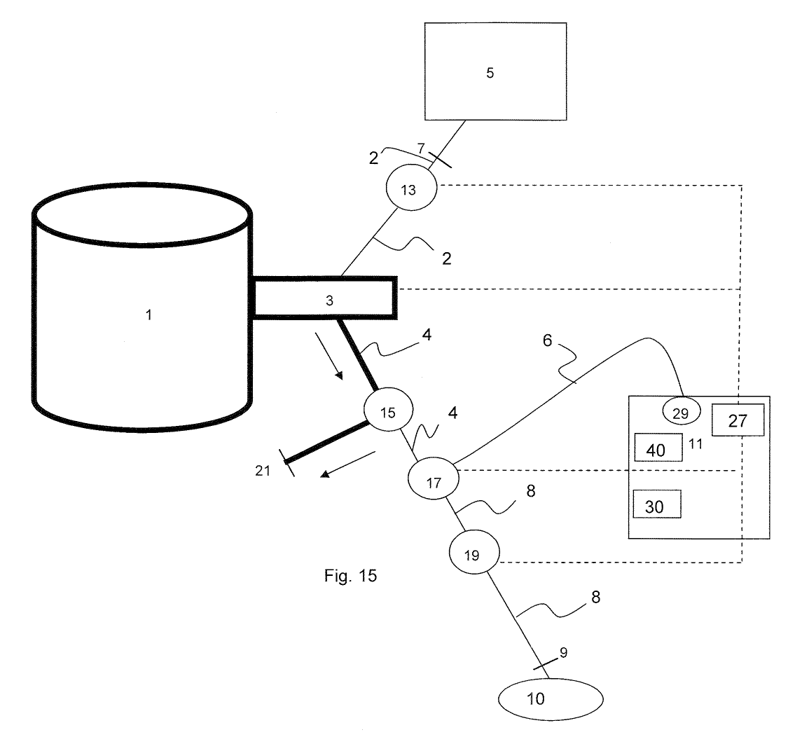

Immediately prior to the sampling operation, drain valve 19 closes so that fluid samples cannot flow to drain 10. As shown in FIG. 14, sample valve 3 isolation valve 17, and internal valve 29 are opened and a sample is allowed to flow from the fluid sample source 1, through the sampling valve 3, steam/sample channel 4, isolation valve 17, and sample transfer channel 6 into the processing system 11, where the sample may be processed and analyzed. FIG. 11 shows sampling valve 3 during the sampling operation in detail. Valve head 31 is removed from port 33 by pneumatic control and fluid is allowed to flow from fluid sample source 1 through steam/sample channel 4. The steam valve 13 along the steam channel 2 prevents fluid samples from flowing to the steam source. Alternatively, as shown in FIG. 15, a sample may be taken manually via manual sample valve 15, which routes the sample from sampling valve 3 to sample output port 21. Immediately subsequent to the sampling operation, the system may perform an additional sanitizing and sterilizing operation in the manner described above.

Immediately prior to the sampling operation, drain valve 19 closes so that fluid samples cannot flow to drain 10. As shown in FIG. 14, sample valve 3 isolation valve 17, and internal valve 29 are opened and a sample is allowed to flow from the fluid sample source 1, through the sampling valve 3, steam/sample channel 4, isolation valve 17, and sample transfer channel 6 into the processing system 11, where the sample may be processed and analyzed. FIG. 11 shows sampling valve 3 during the sampling operation in detail. Valve head 31 is removed from port 33 by pneumatic control and fluid is allowed to flow from fluid sample source 1 through steam/sample channel 4. The steam valve 13 along the steam channel 2 prevents fluid samples from flowing to the steam source. Alternatively, as shown in FIG. 15, a sample may be taken manually via manual sample valve 15, which routes the sample from sampling valve 3 to sample output port 21. Immediately subsequent to the sampling operation, the system may perform an additional sanitizing and sterilizing operation in the manner described above.

In some embodiments, where even the smallest amount of the batch material is highly valuable, the dead volume of the sample transfer channel 6 is sized as small as possible to avoid drawing more fluid sample than is needed for analysis. Typically, the sample transfer channel 6 has an inner diameter between about 1 mm and about 2 mm, and a dead volume of less than about 60 ml. Thus provided is a safer, more consistent sterile sampling system that minimizes sample waste and performs sampling operations automatically.

To ensure that the system extracts a quality sample for analysis, i.e., a sample that is representative of the batch, the fluid lines of the system are primed. In other words, during the sampling operation, the system extracts more fluid than necessary to perform an analysis. For example, a total of 30 ml of the batch is extracted in order to obtain a 10 ml aliquot; the first 20 ml is primer to flush the fluid lines of residual fluid and the final 10 ml is the actual sample to be analyzed. This practice is typical for previously known manual systems as well as the presently described system, and it prevents the analysis sample from being diluted by residual fluid as it flows through the system. In contrast to previously known manual systems, the present automated system is capable of consistently and accurately providing the exact amount of fluid sample required to prime the fluid lines, thus minimizing waste of the sample.

The quality of an automatically extracted sample is evaluated by comparing output values of the sample to known output values of the batch. A sample is of acceptable quality only when the output values of the samples equal the output values of the batch. A system that dispenses acceptable samples is considered “primed.” For the purpose of comparison, the output values for manually extracted sample are considered to represent the actual output values of the batch. That is, known output variables, such as cell count and glucose concentration, are determined from samples manually extracted from the batch and are used as a base line for comparison against the automatically extracted samples. Therefore, the system is considered “primed” when the output values of the samples of the automated system match the output values of the samples extracted manually. It is understood that the manually extracted sample used for comparison is provided by a manual system that has already been primed.

When the above described automated system is applied to batch processes of homogeneous fluids, the amount of sample required to prime the system is comparable to that required when the sample is extracted manually. However, the above system requires priming with significantly larger quantities of fluid sample when the sample to be analyzed is a heterogeneous fluid, such as a mammalian cell culture.

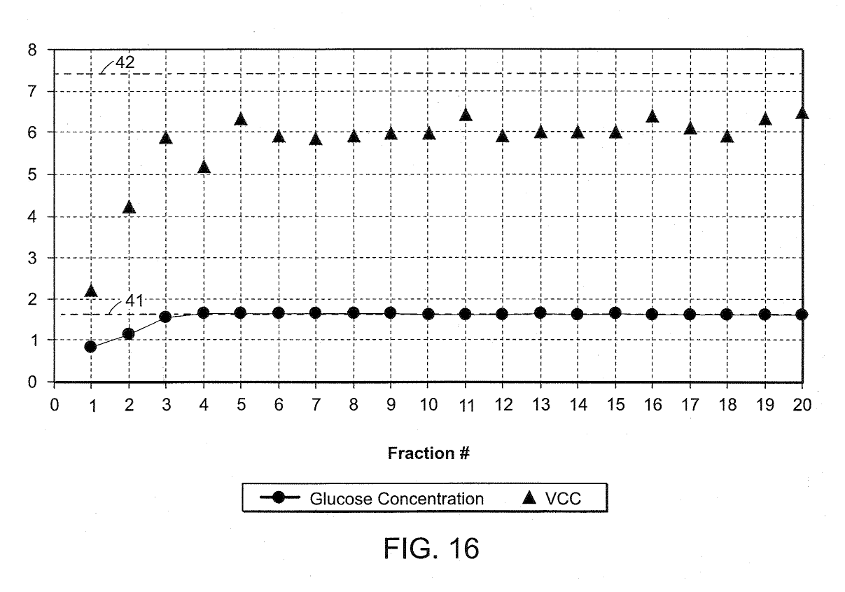

For example, FIG. 16 shows data for glucose concentration and viable cell count (VCC) for 20 aliquots of 10 ml each extracted from a batch in sequence. The aliquots tested for glucose concentration are homogeneous fluid samples, while the aliquots tested for VCC are heterogeneous fluid samples. The circles indicate actual glucose concentration for each of the 20 aliquots, and dotted line 41 indicates the known glucose concentration of the batch (as measured from a batch sample extracted by a primed manual system). The first three aliquots are dilute as a result of residual fluid in the fluid lines. By aliquot number four, the glucose concentration has reached steady state, and is equal to the actual glucose concentration of the batch. Thus, the first 30 ml of fluid sample were needed to prime the system to provide a truly representative aliquot, i.e., one that would yield an accurate value for the particular output variable (glucose concentration) of the homogeneous fluid.

However, the system could not sufficiently be primed by the heterogeneous fluid to provide a representative sample for VCC. The triangles represent the VCC in the fluid for each aliquot, while dotted line 42 indicates the known VCC of the batch (as measured from a batch sample extracted by a primed manual system). Like the first aliquots tested for glucose, the first four aliquots of the tested for VCC are substantially dilute, and a steady state concentration is reached shortly thereafter. However, unlike the steady state reached by the homogeneous fluid for glucose concentration, the steady state level achieved by the heterogeneous fluid for VCC is not equal to the value observed in the batch. Thus, even after 200 ml of priming, the system could not provide an aliquot that was truly representative of the batch. Because the experiment was terminated after the 20^{th} aliquot, the actual volume of batch fluid required to achieve a representative sample was not determined. In any case, the cost of wasting such relatively large quantities of fluid for the purposes of priming the system for an accurate sample is prohibitive in most, if not all applications. Several features can be added to the above described system to increase sample quality and ensure automated delivery of representative batch samples.

It was unexpectedly found that orienting the isolation valve so that the drain outlet port points in an upwardly direction reduces the level of dilution in samples extracted by the system, thereby improving sample quality. In particular, it was found that a quality sample can be obtained when the isolation valve drain outlet port protrudes upwardly from the isolation valve and has a longitudinal axis that is angled at less than about 45° with from vertical. As used herein, the term “vertical” refers to a line parallel to a gravitational force vector. As used herein, “upward” refers to a direction that is at least partially opposite the gravitational force vector. As used herein, “protrude” means to project outwardly from a particular object in space.

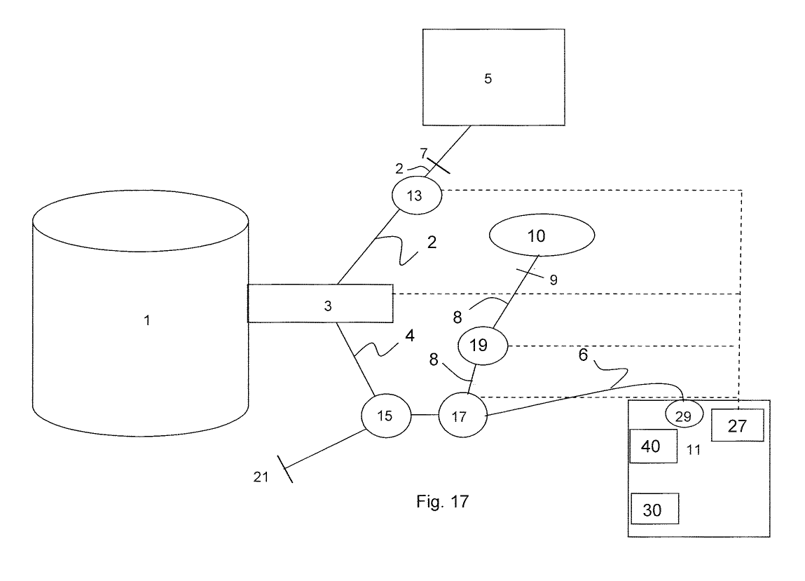

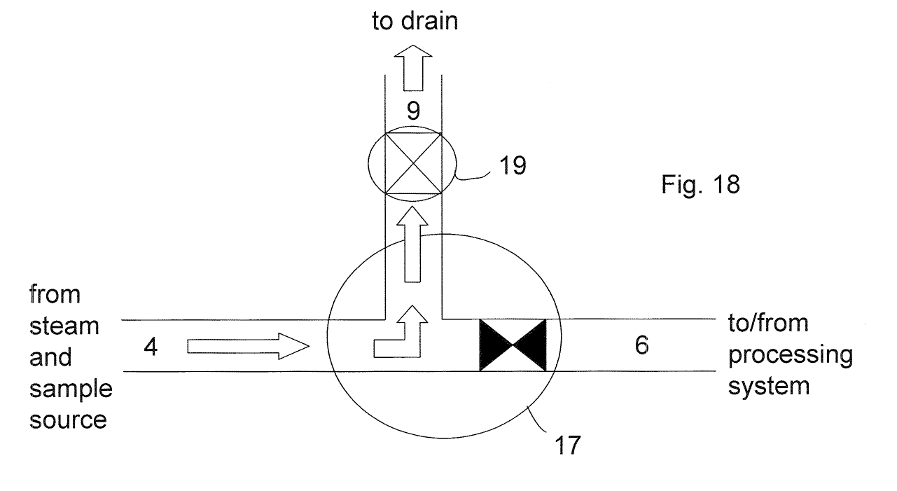

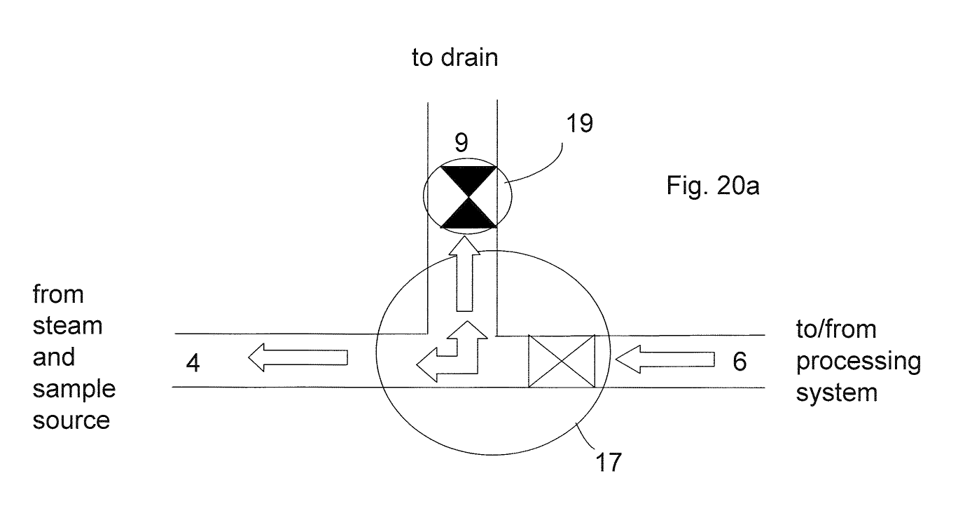

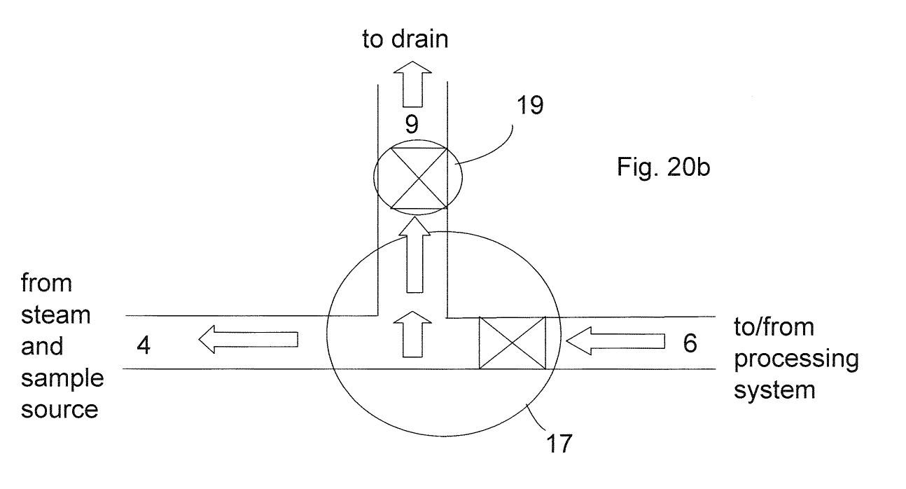

The system for automated sterile sampling of a vessel described above can therefore be improved by reorienting the system components as shown in FIG. 17. Drain channel 8 is now located above isolation valve 17. FIGS. 18-20b show the improved orientation of the isolation valve 17 in detail. FIGS. 18, 19, 20a and 20b respectively correspond to FIGS. 3, 4, 5a, and 5b, which represent the original setup. The sterilizing, sampling, and sanitizing operations are carried out as described previously.

Surprisingly, using the above described configuration yielded samples having output variables, such as lactate concentration, ammonium concentration, and VCC, that more closely matched those of the samples extracted manually. Lactate and ammonium concentrations are indicators of metabolic activity of cells. Higher concentrations of lactate and ammonium in a fluid sample suggest that more cells exist in the fluid sample. Thus, lactate concentration, ammonium concentration, and VCC are each directly or indirectly indicators of the quantity of cells in the fluid sample, and therefore important output variables of a heterogeneous fluid (cells in suspension).

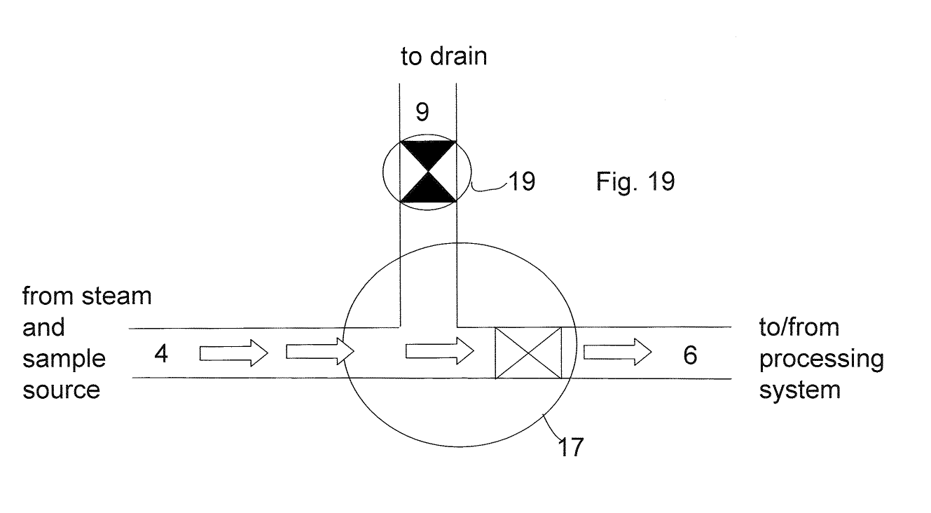

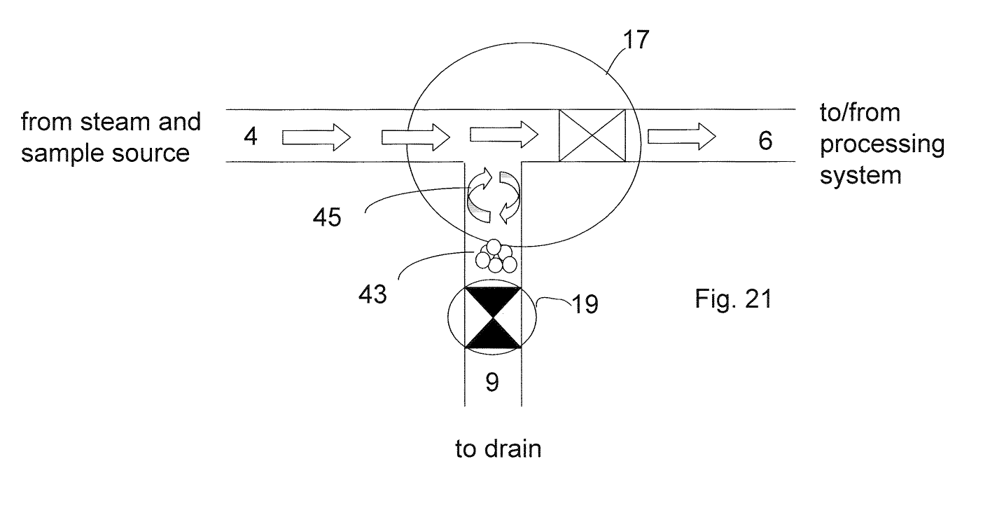

Without wishing to be bound to a theory, it is believed that orienting the isolation valve so that the drain outlet port protrudes upwardly from the isolation valve and has a longitudinal axis that is angled less than about 45° with from vertical prevents steam condensate from pooling in drain channel 9. If the drain outlet port is pointed downwardly, as in FIG. 21 (also FIG. 4), a pool 43 of steam condensate is formed in the well above drain valve 19 after the sterilizing process. It is believed that pool 43 dilutes the sample as it passes from the isolation valve 17 to the processing system 11. Also, cells from the fluid sample become trapped in the well as sample flows to the channel 6. The well creates a cell collecting trap 45, which allows the cells to settle out of suspension. By eliminating the formation of the condensate pool 43 and eliminating the cell collecting trap 45 below the sample path, the fluid samples are less dilute. As shown in FIG. 19, steam drain channel 9 has been reoriented from being a “well” to being a “stack.” In the improved system, gas may collect in the stack, but condensate will be purged during an initial purge process prior to sampling. The cells cannot settle out because the stack is above the flow of the sample, and the sample cannot become dilute because there is no condensate to dilute the sample.

As described above, the manual sampling valve 15, isolation valve 17, and drain valve 19 of the sampling system each has a ⅜ inch inner diameter port. This sizing had been considered appropriate for both homogeneous and heterogeneous fluid samples. However, it was found that the dimensions of the valve ports and fluid lines substantially impacted sample quality for heterogeneous fluids. More specifically, it was discovered that sample quality is improved when the inner diameters of the valves ports and fluid lines were decreased. This was determined after the original manual sampling valve 15, isolation valve 17, and drain valve 19 of the sampling system were each replaced with a corresponding smaller valve having ¼ inch inner diameter ports. It is therefore preferable that the valve ports and fluid lines downstream from the sampling valve have an inner diameter that is less than 8 mm. This number was determined to be appropriate because the ⅜ inch (9.5 mm) diameter valves did not work as well as the ¼ inch (6.3) diameter valves. A system having lines of an inner diameter of 8 mm could not be tested because no valve sizes between ¼ inch and ⅜ inch exist for the valves specified in detail above.

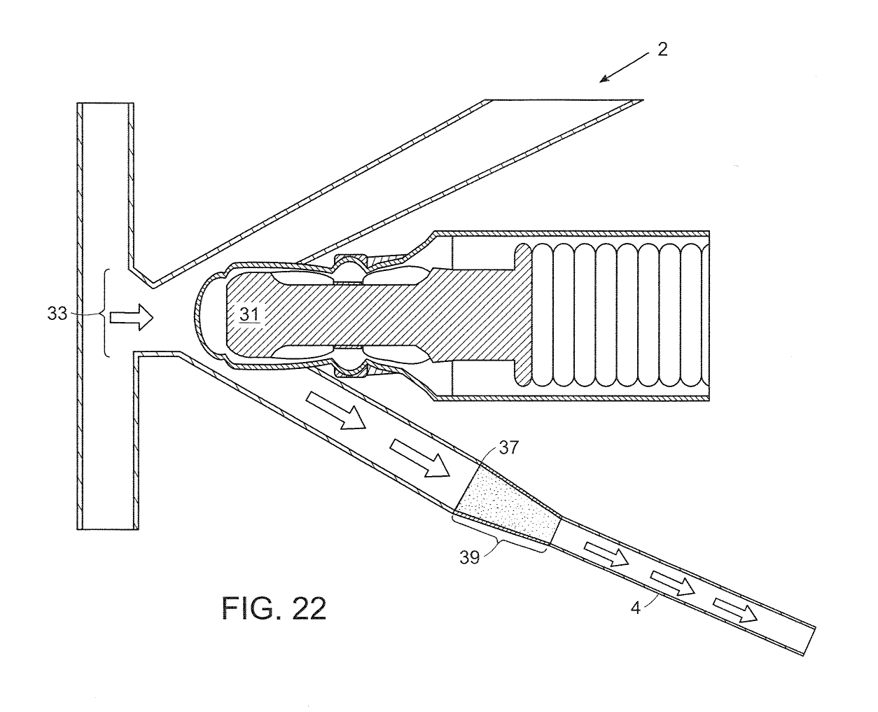

In addition to valve resizing, transitions between substantial changes in fluid path size were added. As previously described, ports of the sampling valve 3 have an inner diameter of over 9 mm, while the steam/sample transfer channel connected to it was changed (by virtue of the valve resizing described in the preceding paragraph) to a ¼ inch (0.63 mm) inner diameter. Thus, junction between the sampling valve outlet port 37 and the steam/sample transfer channel had a substantial decrease in inner diameter. The connection was modified to have a tapered transition 39 between the sampling valve outlet port and the steam/sample transfer channel, as shown in FIG. 22. A similar transition was added to the connection between the isolation valve sample transfer port, which, as resized, has a ¼ inch (0.63 mm) inner diameter, and sample transfer channel 6, which typically has an inner diameter of about less than 2 mm.

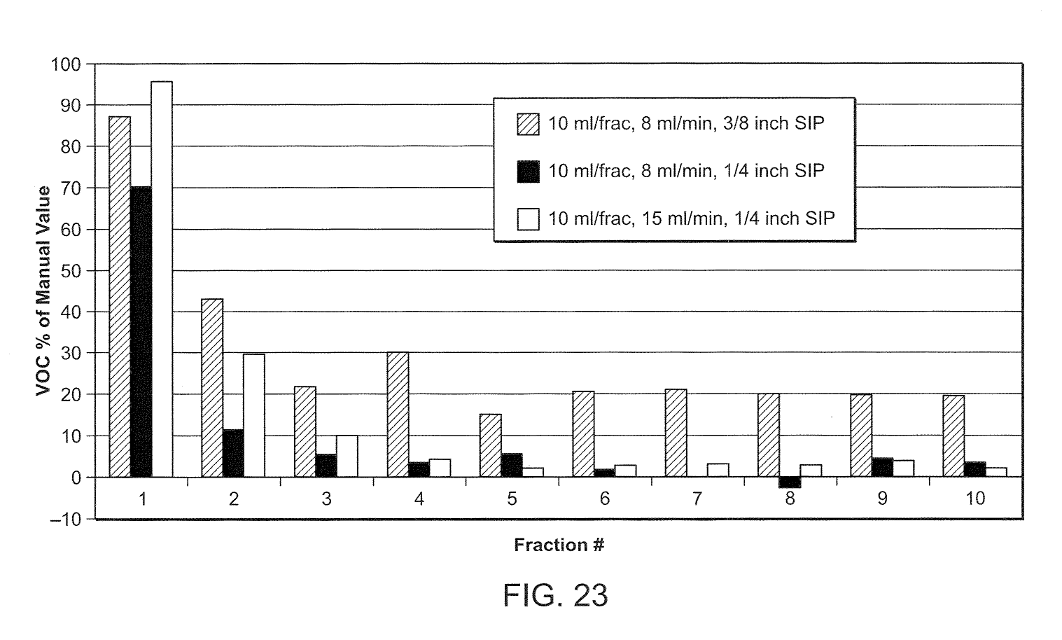

These modifications in combination yielded a surprisingly substantial reduction of variance in cell count between automatically extracted samples and manually extracted samples. FIG. 23 shows the cell count variance of 10 automatically extracted samples taken in sequence using the both original and modified automated sampling system. The actual cell count was known, as measured from manually extracted samples. The original sampling system (⅜ inch) extracted 10 samples at 8 ml/min. The modified sampling system (¼ inch) extracted 10 samples at 8 ml/min and 10 samples at 15 ml/min. The ordinate represents the percent variance of the VCC values with respect to the VCC measured from a manually extracted sample. FIG. 23 shows that cell counts from samples extracted by the modified system more closely resemble the cell count of the manual batch sample than those extracted by the original setup. By sample number 10, the original sampling system still yielded samples that had 20% fewer cells, and thus was not primed.

Again without wishing to be bound by a theory, it is believed that the concentration of a heterogeneous fluid remains dilute in the above described system because the heavy phases (such as cells) are permitted to settle out when the linear velocity of the fluid in the system is too low. Decreasing the inner diameter of the valve ports and fluid lines increases the linear velocity of the fluid, thereby maintaining sufficient turbulence in the fluid to keep the cells in suspension while still maintaining the same flow rate. Furthermore, tapered transitions are believed to eliminate dead zones where cells can become trapped.

FIG. 23 also suggests that the system can be optimized for sample flow rate, since samples extracted under the higher flow rate of 15 ml/min had an increased variance compared to samples extracted at a rate of 8 ml/min under the same system sizing and configuration. Without wishing to be bound by a theory, it is believed that shear forces on the cell walls resulting from fluid turbulence of higher flow rates causes fragmentation to the cells, while insufficient flow causes the cells to settle out of the fluid suspension.

The teachings of all patents, published applications and references cited herein are incorporated by reference in their entirety. While this invention has been particularly shown and described with references to example embodiments thereof, it will be understood by those skilled in the art that various changes in form and details may be made therein without departing from the scope of the invention encompassed by the appended claims.

What is claimed is:

1. An automatic sterile sampling system for sampling fluid, comprising:
a steam valve;
a sampling valve having a steam inlet port in fluid communication with the steam valve, a sample inlet port, and an outlet port, the outlet port having a first inner diameter;
a processing system comprising a cleaning fluid source and in fluid communication with a sample transfer channel, the sample transfer channel having a second inner diameter less than the first inner diameter;
an isolation valve having an inlet port in fluid communication with the outlet port of the sampling valve, a drain outlet port, and a sample transfer port in fluid communication with the sample transfer channel, the inlet port and sample transfer port having a third inner diameter less than the first inner diameter and larger than the second inner diameter; and
a controller.

2. The system of claim 1, wherein the second inner diameter and first inner diameter are less than 8 mm.

3. The system of claim 2, having a tapered transition between the outlet port of the sampling valve and the inlet port of the isolation valve and a tapered transition between the sample transfer port of the isolation valve and the sample transfer channel.

4. The system of claim 3, wherein the isolation valve drain outlet port protrudes upwardly from the isolation valve and has a longitudinal axis that is angled less than about 45° from vertical.

5. The system of claim 4, further comprising a steam source in fluid communication with the steam valve, a sample source in fluid communication with the sampling valve, and a drain in fluid communication with the isolation valve drain outlet port.

6. The system of claim 1, having a tapered transition between the outlet port of the sampling valve and the inlet port of the isolation valve and a tapered transition between the sample transfer port of the isolation valve and the sample transfer channel.

7. The system of claim 6, wherein the isolation valve drain outlet port protrudes upwardly from the isolation valve and has a longitudinal axis that is angled less than about 45° from vertical.

8. The system of claim 1, wherein the isolation valve drain outlet port protrudes upwardly from the isolation valve and has a longitudinal axis that is angled less than about 45° from vertical.

9. The system of claim 1, further comprising a steam source in fluid communication with the steam valve, a sample source in fluid communication with the sampling valve, and a drain in fluid communication with the isolation valve drain outlet port.

10. A method for automatic aseptic sampling from a fluid sample source, comprising the steps of:
providing a steam source, a steam valve connected the steam source, a sampling valve connected to the fluid sample source, an isolation valve, a processing system, a drain valve, a drain, and a controller; and
employing the controller to:
pass cleaning fluid from the processing system through the isolation valve to the drain;
pass steam through the steam valve, sampling valve, and isolation valve to the drain for a duration sufficient to sterilize the sampling valve, the isolation valve, and a fluid path therebetween; and
pass fluid sample from the fluid sample source through the sampling valve and isolation valve to the processing system.

11. The method of claim 10, further comprising the step of increasing the linear velocity of fluid through the system by providing an inner diameter less than about 8 mm through the sampling valve, isolation valve, and a fluid path to the processing system.

12. The method of claim 11, further comprising the step of providing a tapered transition between the sampling valve and isolation valve and providing a tapered transition between the isolation valve and the processing system.

13. The method of claim 12, further comprising the step of orienting a drain outlet port of the isolation valve to protrude upwardly from the isolation valve and to have a longitudinal axis that is angled less than about 45° from vertical.
